(19) United States
(12) Patent Application Publication
(10) Pub. No.: US 2014/0212212 A1
(43) Pub. Date: Jul. 31, 2014

(54) DRIVE FOR ROTATING DRUM

(71) Applicant: Risley Enterprises Ltd., Grande Prairie (CA)

(72) Inventor: Reggald Emory Isley, Grande Prairie (CA)

(73) Assignee: Risley Enterprises Ltd., Grande Prairie (CA)

(21) Appl. No.: 14/165,808

(22) Filed: Jan. 28, 2014

Related U.S. Application Data
(60) Provisional application No. 61/757,665, filed on Jan. 28, 2013.

(51) Int. Cl. F16D 1/06

(52) U.S. Cl. CPC F16C 1/04
USPC 403/359.1

(57) ABSTRACT

A drive mechanism for driving a drum, such as a mulcher drum comprises an intermediate shaft coupled to drive the drum by way of a flexible coupling. The flexible coupling may be located on an inside of a hub of the drum. A hydraulic or other motor is coupled to drive the intermediate shaft by a splined coupling. Lubrication of the splined coupling is enhanced by a supply of grease contained in a central passage within the intermediate shaft. The drive mechanism may be direct drive from a hydraulic or other suitable motor. The drive mechanism can be compact and robust against collateral damage resulting from failure of drum support bearings.

### REFERENCE TO RELATED APPLICATIONS

This application claims the benefit under 35 U.S.C. §119 of U.S. Application No. 61/757665 filed 28 Jan. 2013 and entitled DRIVE FOR ROTATING DRUM which is hereby incorporated herein by reference for all purposes.

### TECHNICAL FIELD

This invention relates to mechanisms for driving rotating drums. Example embodiments provide drive systems suitable for turning the drums of subsurface mulchers.

### BACKGROUND

There are various industrial applications in which it is necessary to drive a drum with a hydraulic motor or other power source. Some examples are the drums of mulchers, log feed rollers, tree chippers and the like. In some cases, drums are driven by chains, belts, or other intermediate mechanisms. It can be desirable, however, to provide direct drive of a drum from a power source such as a hydraulic motor.

In some drum drive systems a splined shaft on the power source engages a splined socket on the drum. A significant problem that can occur in such systems is that any misalignment between the axis of rotation of the motor and the axis of rotation of the drum can result in potentially destructive forces being applied to the splines, motor shaft and/or the drum. This problem is exacerbated because the shaft of the hydraulic motor or other driving mechanism and the drum are typically both supported by bearings which do not accommodate relative motion of the motor and drum transverse to the axis of drum rotation. Another problem with such systems is keeping the splined connection properly lubricated.

These problems are made worse in extreme service applications. Driving a mulcher drum is an example of an extreme surface application. In a mulcher, the drive system, drum and support bearings are subjected to strong shocks and vibration. These extreme conditions can result in bearing failures. Even if the drum and motor start out perfectly aligned, a bearing failure can result in radial runout that can, in turn, damage a coupling between motor and drum and/or the motor itself. Thus, failure of a bearing can quickly lead to the requirement of repairs much more extensive and expensive than replacing the failed bearing.

There is a need for driving mechanisms for drums and the like which avoid some of the disadvantages of the prior art.

### SUMMARY

The invention has a number of aspects. One aspect provides mechanisms suitable for driving drums. An non-limiting example application is driving the drums of mulchers as are used in forestry, clearing rights of way and the like. However, the mechanism described herein is not limited to driving drums but may also be applied in driving other rotating structures. Mechanisms as described herein include an intermediate shaft and a flexible coupling.

An example aspect provides a drive mechanism for a drum. The drive mechanism comprises an intermediate shaft extending from an outer end through an axial bore in a hub of the drum. The axial bore is larger in diameter than the intermediate shaft so as to provide clearance between the axial bore of the hub and the intermediate shaft. The intermediate shaft is coupled to drive a flexible coupling on an inner side of the drum. A motor is coupled to drive the outer end of the intermediate shaft.

Another aspect provides a construction for maintaining lubrication of a splined coupling. The construction provides a passage extending axially along an axis of rotation of a female part of a splined coupling. The passage is smaller in diameter than the female part such that grease or other lubricant can be urged from the passage into the female part of the splined coupling by centrifugal forces. A grease relief fitting may be provided at an end of the passage away from the female part of the splined coupling. This lubrication construction may be used together with drive mechanisms as described above but also has application in other situations.

Further aspects and features of example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a cross section through a drum drive mechanism according to an example embodiment.

FIG. 2 is a schematic illustration indicating lubrication paths.

FIG. 3 is a cross section of an intermediate shaft and flexible coupling assembly.

FIG. 4 is a perspective view of a mulcher head according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

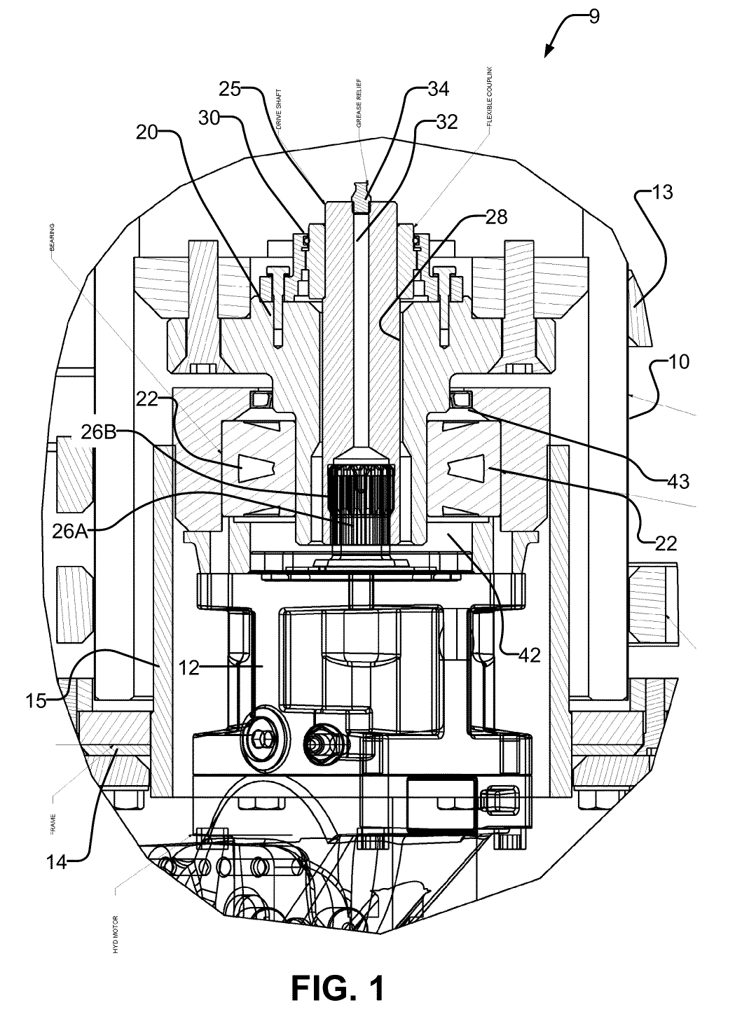

FIG. 1 shows a drum drive mechanism 9 according to an example embodiment. A drum 10 is driven by a motor 12. Motor 12 may, for example comprise a hydraulic motor. In the illustrated embodiment drum 10 has cutting teeth 13 on its exterior surface. Drum 10 may, for example, comprise a mulcher drum. Cutting teeth 13 may be designed to shred trees and mulch rocky soil. Cutting teeth 13 may, for example, comprise suitable carbide teeth.

Motor 12, which may be a hydraulic motor, for example, is mounted to a frame 14 of a machine of which drum 10 is a part. Drum 10 is mounted for rotation relative to frame 14. In the illustrated embodiment, frame 14 comprises a tubular drum support 15. Drum 10 comprises a hub 20. A bearing 22 is provided between hub 20 and drum support 15. Bearing 22 allows hub 20 to rotate relative to frame 14.

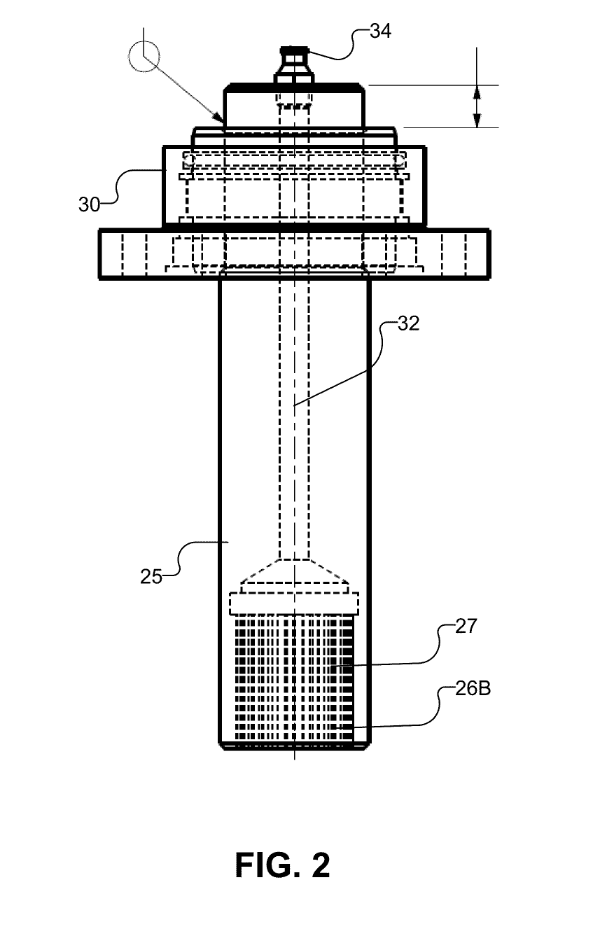

Hydraulic motor 12 has a drive shaft 24. Drive shaft 24 is coupled to rotate drum 10 by way of an intermediate shaft 25 and a flexible coupling 30. FIG. 2 shows intermediate shaft 25 and flexible coupling 30. Flexible coupling 30 is a coupling of a type which can transmit torque but which can tolerate some angular misalignment between driving and driven parts. Flexible coupling 30 may, for example, comprise a gear coupling. Flexible coupling 30 may, for example, comprise one half of a suitably-sized Series H flexible gear coupling available under the brand name KOP-FLEX™ from Emerson Industrial Automation.

In the illustrated embodiment, intermediate shaft 25 passes through to the inside of hub 20 and flexible coupling 30 is located on the inside of hub 20 (away from motor 12). Flexible coupling is inboard of bearing 22. This arrangement allows intermediate shaft 25 to be relatively long such that radial runout of hub 20 that could occur (for example due to failure of bearing 22) will result in relatively small changes in the angle of intermediate shaft 25.

Intermediate shaft 25 is coupled to drive flexible coupling 30. For example, in some embodiments, intermediate shaft 25 is welded to the hub of flexible coupling 30. In other embodiments, shaft 25 is coupled to drive the hub of flexible coupling 30 by way of a torsionally flexible shock-absorbing coupling (not shown).

Motor drive shaft 24 is coupled to drive intermediate shaft 25. For example, in the illustrated embodiment, motor shaft 24 and intermediate shaft 25 are coupled by a splined coupling. Exterior splines 26A on drive shaft 24 engage interior (female) splines 26B in a longitudinally-extending bore 27 at the outer end of intermediate shaft 25.

Intermediate shaft 25 passes through a bore 28 in hub 20. Bore 28 is dimensioned to provide clearance around intermediate shaft 25. This construction can accommodate some misalignment between motor 12 and the axis of rotation of drum 10. Furthermore, in the event of the failure of bearing 22, another bearing supporting drum 10, or a bearing of motor 12, intermediate shaft 25 can accommodate resulting relative motions of drum 10 and motor 12 so that additional damage that might otherwise occur as a result of the degradation and failure of one or more of these bearings may be very significantly reduced.

Another significant set of features of the illustrated drive mechanism relate to lubrication, particularly of the splined coupling between motor shaft 24 and intermediate shaft 25. To this end, intermediate shaft 25 has a longitudinal passage 32 extending along intermediate shaft 25 from bore 26. Passage 32 is smaller in diameter than bore 26. Passage 32 serves as a reservoir for grease or other lubricant. Grease located in passage 32 is subject to centrifugal forces when intermediate shaft 25 rotates. These forces urge the grease radially outwardly. If, during use, grease is present in passage 32 then the rotation of intermediate shaft 25 tends to pump grease outwardly into bore 26 where it can lubricate splines 26A and 26B. In some embodiments, passage 32 is tapered in diameter with a larger diameter end opening into bore 26 to facilitate delivery of grease into bore 26. In the illustrated embodiment passage 32 opens into bore 27 with a tapered transition.

Passage 32 may be filled with grease in various ways. In an example embodiment, when grease is introduced into the area of splines 26A and 26B (as discussed in more detail below) the grease or other lubricant can proceed past the splines into longitudinal passage 32. A relief fitting 34 at the end of shaft 25 away from motor 12 permits any air to exit from passage 32. After this lubrication has been performed, passage 32 is filled with grease or other lubricant.

Centrifugal forces which occur when shaft 25 rotates tends to cause the lubricant to be urged outwardly relative to the axis of rotation of shaft 25. As a result, lubricant is drawn from passage 32 into bore 27 and is urged outwardly by centrifugal forces into the area of splines 26A and 26B. The reservoir of grease in passage 32 therefore helps to keep the splined coupling between motor shaft 24 and intermediate shaft 25 well lubricated.

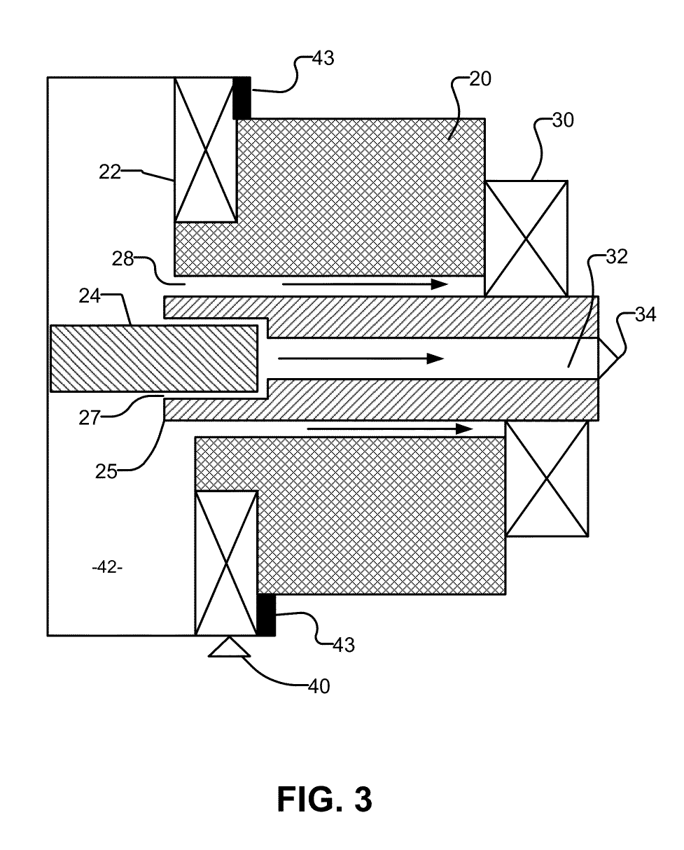

A specific example of how lubrication may be delivered is illustrated schematically in FIG. 3. A grease fitting 40 may be supplied through which grease may be introduced into bearing 22. When the grease has filled bearing 22, the grease flows into space 42 between motor 12 and bearing 22. Grease is prevented from exiting on an opposing side of bearing 22 by a seal 43.

From space 42 the grease can continue in two directions. Some grease enters bore 27 around the outside of motor shaft 24, passes between splines 26A, 26B and enters passage 32. At the end of passage 32, grease may exit through grease relief port 34. Relief port 34 may comprise a pressure relief valve that is configured to open when the pressure within passage 32 reaches a set value. The pressure at which grease relief port 34 opens may be selected such that grease relief port will open at a pressure lower than would be required to damage seals upstream from grease relief port 34 (e.g. seal 43 and/or other seals that are not mentioned above).

Grease can also exit from space 42 around the outside of intermediate shaft 25 into the clearance 28 between intermediate shaft 25 and hub 20. This grease can flow to flexible coupling 30 where it lubricates coupling 30. Grease located within clearance 28 can provide damping of any transverse motion of intermediate shaft 25 within hub 20 as might occur, for example, due during or after a failure of bearing 22.

In some embodiments, the clearance between shaft 25 and hub 20 is on the order of an eighth of an inch or more. In some embodiments, the clearance is increased at the end of shaft 25 closest to motor 12. This increase in clearance provides for larger motion of hub 20 without contact between shaft 25 and hub 20 in the case of a failure of bearing 22 and also provides an expanded region for receiving grease and directing that grease into the clearance space 28 around shaft 25.

Although a lubrication arrangement as described herein is well suited for use in combination with the drum drive mechanism as described above, this lubrication arrangement may also be applied in other contexts where splined couplings require lubrication.

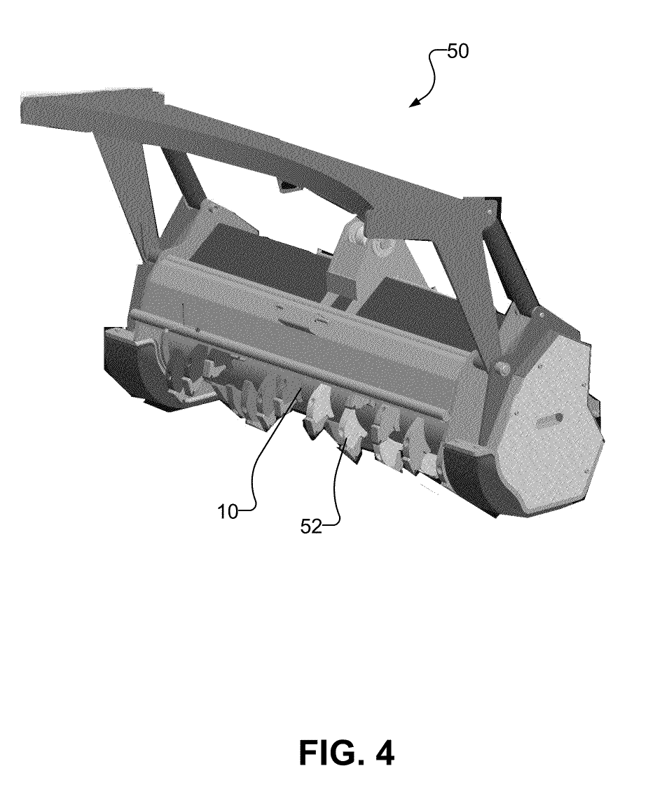

FIG. 4 shows a mulcher head 50 comprising a drum 10 as may be driven by the mechanism described above. Drum 10 carries teeth 52.

Drive systems as described herein may be used in a wide variety of applications. Whereas such drive systems have particular utility in driving mulcher drums (which are typically subjected to extreme forces in operation) such couplings may be used in a wide variety of other applications such as driving drums for industrial shredders, driving log feed rolls, driving feed rolls in industrial facilities, and the like. While a direct drive is shown, and has advantages, in simplicity and compactness as compared to non-direct drives, a similar arrangement could be used to provide a belt drive for a drum. In such applications, sheaves for one or more belts or one or more gears or the like could be provided in place of motor 12.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A drive mechanism for a drum comprising:
an intermediate shaft extending from an outer end through an axial bore in a hub of the drum, the axial bore being larger in diameter than the intermediate shaft so as to provide clearance between the axial bore of the hub and the intermediate shaft, the intermediate shaft coupled to drive a flexible coupling on an inner side of the drum, and,
a motor coupled to drive the outer end of the intermediate shaft.

2. A drive mechanism according to claim 1 wherein the motor is coupled to drive the intermediate shaft by way of a splined coupling, the splined coupling provided by female splines in an axial bore in the end of the intermediate shaft and male splines on a shaft of the motor.

3. A drive mechanism according to claim 2 comprising a passage extending axially along the intermediate shaft from the axial bore, the passage having a diameter smaller than that of the axial bore.

4. A drive mechanism according to claim 3 comprising a pressure relief valve at an inner end of the passage.

5. A drive mechanism according to any of claims 1 to 4 wherein the drum is mounted for rotation relative to a frame by a bearing and the intermediate shaft passes through an inner race of the bearing.

6. A drive mechanism according to claim 5 wherein the motor is rigidly mounted to the frame.

7. A drive mechanism according to any one of claims 1 to 6 wherein the flexible coupling comprises a flexible gear coupling.

8. A drive mechanism according to any one of claims 1 to 7 wherein the drum comprises teeth on an outer surface thereof.

9. A drive mechanism according to claim 7 or 8 wherein the drum has a cylindrical outer surface.

10. A drive mechanism according to claim 9 wherein the drum is a mulcher drum.

11. A splined coupling comprising:
a first part comprising internal splines in a bore dimensioned to receive a second part comprising external splines dimensioned to interfit with the internal splines; a passage in fluid communication with the bore extending longitudinally along one of the first and second parts, the passage having a diameter smaller than the bore.

12. A splined coupling according to claim 11 comprising a pressure relief valve at an end of the passage away from the bore.

13. A splined coupling according to claim 11 or 12 wherein the passage is aligned with an axis of rotation of the splined coupling.
